(19) United States
(12) Patent Application Publication
(10) Pub. No.: US 2025/0221427 A1
(43) Pub. Date: Jul. 10, 2025

(54) A FAT COMPOSITION COMPRISING A VEGETABLE FAT PHASE WHICH IS FREE FROM PALM OIL AND/OR FRACTIONS THEREOF

(71) Applicant: AAK AB (PUBL), Malmö (SE)

(72) Inventor: Morten Daugaard ANDERSEN, Aarhus C (DK)

(21) Appl. No.: 18/850,670

(22) PCT Filed: Apr. 4, 2023
(86) PCT No.: PCT/SE2023/050306

§ 371 Date: Sep. 25, 2024

(30) Foreign Application Priority Data
Apr. 7, 2022 (SE) 2250442-07

(51) Int. Cl. A23G 1/38; A23D 9/04; A23G 3/40

(52) U.S. Cl. CPC A23G 1/38; A23D 9/04; A23G 3/40

(57) ABSTRACT

The present invention relates to a fat composition comprising a vegetable fat phase, wherein the vegetable fat phase is free from palm oil and/or fractions thereof and also relates to the use of the fat composition. The invention further relates to a confectionary or chocolate or chocolate-like filling or spread product comprising the fat composition.

### TECHNICAL FIELD OF THE INVENTION

The present invention relates to a fat composition comprising a vegetable fat phase, wherein the vegetable fat phase is free from palm oil and/or fractions thereof and also relates to the use of the fat composition. The invention further relates to a confectionary or chocolate or chocolate-like filling product comprising the fat composition.

### BACKGROUND OF THE INVENTION

Palm oil is an extremely versatile oil that has many different properties and functions that makes it so useful and so widely used. It is semi-solid at room temperature so can keep spreads spreadable; it is resistant to oxidation so can give products a longer shelf-life; it's stable at high temperatures so helps to give fried products a crispy and crunchy texture; and it's also odourless and colourless so doesn't alter the look or smell of food products.

As well as being versatile, compared to other vegetable oils the oil palm is a very efficient crop, able to produce high quantities of oil over small areas of land, almost all year round. This makes it an attractive crop for growers and smallholders, who can rely on the steady income that palm oil provides.

Palm oil is also found as an important component in cocoa butter equivalents (CBEs), such as Palm mid fractions being an important component in filling fats.

Unfortunately, palm oil has been and continues to be a major driver of deforestation of some of the world's most biodiverse forests, destroying the habitat of already endangered species like the Orangutan, pygmy elephant, and Sumatran rhino. This forest loss coupled with conversion of carbon rich peat soils are throwing out millions of tonnes of greenhouse gases into the atmosphere and contributing to climate changes. There also remains some exploitation of workers and child labour. These are serious issues that the whole palm oil sector needs to address.

Therefore non-palm oil sources in the vegetable oils and fats industry has become an important subject as an alternative to oil palms. Thus, there is a need in the art for such alternatives.

Accordingly, the main object of the invention is to provide such alternatives.

### SUMMARY OF THE INVENTION

The present invention relates to a fat composition comprising a vegetable fat phase, wherein the vegetable fat phase comprises:
from 85.0% to 100.0% by weight of triglycerides compared to the total weight of the fat phase;
from 50.0% to 99.5% by weight of SatOSat+SatSatO triglycerides compared to the total weight of triglycerides;
from 51.0% to 92.0% by weight of POP+PPO triglycerides compared to the total weight of triglycerides;
from 0.0% to 15.0% by weight of StOSt+StStO triglycerides compared to the total weight of triglycerides;
a ratio of the weight of PPO triglycerides to the weight of POP triglycerides from 0.00 to 0.05;
   wherein the vegetable fat phase is free from palm oil and/or fractions thereof, and wherein Sat is saturated fatty acids selected from C16-, C18-, C20-, C22-, and/or C24-fatty acids, P is palmitic acid (C16:0), St is steric acid (C18:0), and O is oleic acid (C18:1).

The fat composition as disclosed herein shows the possibility to produce confectionary or chocolate-like filling compounds without the use of a palm-based vegetable fat phase without compromising the quality. As can be seen by the examples provided herein, it is possible to make a fillings based on a non-palm oil source as the predominant vegetable fat components in the fat phase, where the resulting chocolate or chocolate-like products is as bloom stable as a product made with a traditional palm-based filling, i.e. the composition of the present invention does not show any visible crystals on the surface of the fillings due to recrystallization, even after a considerable amount of time.

This also means that the present invention as disclosed herein can be used to produce chocolate-like compounds, which are as bloom stable as traditional chocolate or chocolate-like compounds.

Further, the present invention is low or absence of asymmetric (SatSatO) TAGs in the filling as compared to a filling comprising Palm mid fraction. This has an added advantage, since the presence of asymmetric TAG's generally result in lower temperature settings in the crystallization and outlet zone of a temper unit, which can have a negative impact to crystallization in the cooling tunnel. Furthermore, a minor impact to texture towards a softer product can also be a consequence of the presence of asymmetric mono-saturated TAGs in the fat composition.

The fat composition as disclosed herein can be used to produce confectionary or chocolate-like filling compounds which are as bloom stable as traditional confectionary or chocolate-like filling compounds comprising palm mid fraction IV 33.

The present invention also relates to use of the fat composition according to the present invention for bakery, dairy, or confectionary filing applications, such as bakery fillings and confectionary fillings; or for chocolate or chocolate-like spreads.

Further disclosed is also a confectionary or chocolate or chocolate-like filling product comprising from 15% to 65% by weight, such as from 20% to 60%, such as from 25% to 55%, such as from 28% to 50%, or such as from 30% to 45% by weight of a fat composition according to the present invention.

Even further disclosed is a fat composition comprising a vegetable fat phase, wherein the vegetable fat phase comprises:
from 85.0% to 100.0% by weight of triglycerides compared to the total weight of the vegetable fat phase;
from 50.0% to 99.5% by weight of SatOSat+SatSatO triglycerides compared to the total weight of triglycerides in the vegetable fat phase;
from 51.0% to 92.0% by weight of POP+PPO triglycerides compared to the total weight of triglycerides in the vegetable fat phase;
from 0.0% to 15.0% by weight of StOSt+StStO triglycerides compared to the total weight of triglycerides in the vegetable fat phase;
a ratio of the weight of PPO triglycerides to the weight of POP triglycerides from 0.00 to 0.05 in the vegetable fat phase;
   wherein the vegetable fat phase is free from palm oil and/or fractions thereof, and wherein Sat is saturated fatty acids selected from C16-, C18-, C20-, C22-, and/or C24-fatty acids, P is palmitic acid (C16:0), St is steric acid (C18:0), and O is oleic acid (C18:1).

### Definitions

In the context of the present invention, the following terms are meant to comprise the following, unless defined elsewhere in the description.

As used herein, the term “vegetable” shall be understood as originating from a plant or a single cell organism. Thus, vegetable fat or vegetable triglycerides are still to be understood as vegetable fat or vegetable triglycerides if all the fatty acids used to obtain said triglyceride or fat is of plant origin or single cell organism origin.

As used herein, the term “triglycerides” may be used interchangeably with the term “triacylglycerides” and should be understood as an ester derived from glycerol and three fatty acids. “Triglycerides” may be abbreviated TG or TAG.

Saturated fatty acids (SAFA) are chains of carbon atoms joined by single bonds, with the maximum number of hydrogen atoms attached to each carbon atom in the chain. Unsaturated fatty acids are chains of carbon atoms joined by single bonds and varying numbers of double bonds, which do not have their full quota of hydrogen atoms attached. An unsaturated fatty acid can exist in two forms, the cis form and the trans form. A double bond may exhibit one of two possible configurations: trans or cis. In trans configuration (a trans fatty acid) the carbon chain extends from opposite sides of the double bond, whereas, in cis configuration (a cis fatty acid) the carbon chain extends from the same side of the double bond.

By using the nomenclature CX means that the fatty acid comprises X carbon atoms, e.g. a C14 fatty acid has 14 carbon atoms while a C8 fatty acid has 8 carbon atoms.

By using the nomenclature CX: Y means that the fatty acid comprises X carbon atoms and Y double bonds, e.g. a C14:0 fatty acid has 14 carbon atoms and 0 double bonds while a C18:1 fatty acid has 18 carbon atoms and 1 double bond.

In general, triglycerides use a “sn” notation, which stands for stereospecific numbering. In a Fischer projection of a natural L-glycerol derivative, the secondary hydroxyl group is shown to the left of C-2; the carbon atom above this then becomes C-1 and that below becomes C-3. The prefix ‘sn’ is placed before the stem name of the compound.

Sn1/sn2/sn3:

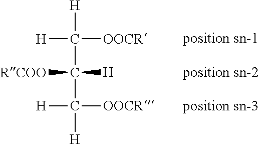

Fischer projection of a natural L-glycerol derivative.

By randomly distributed is meant that the fatty acids is randomly distributed to the three sn-positions. A randomly distributed composition may be obtained by means of esterification, chemical transesterification or enzymatic transesterification. All naturally occurring fat compositions, e.g. virgin olive oil, palm kernel oil, coconut oil or rapeseed oil all have a non-randomly distribution of the fatty acids on the glycerol backbone.

By vegetable fat phase is meant a vegetable fat originating from a plant or a single cell organism. The vegetable fat phase can e.g. be selected from the group of Phulwara oil, such as Phulwara (Diploknema butyracea), Pequi oil, such as Pequi oil (Caryocar brasiliense), High palmitic sunflower oil, Cotton seed oil, Pistachio oil, Buckwheat oil, Andiroba oil, Mahua seed oil, Palash oil, Pilu oil, Sea Buckthorn oil, Shea, Kokum, Illipe, Sal and/or Mango oil, or a blend thereof, and/or fractions thereof. It can also be selected from an interesterified, fractionated, and/or hydrogenated version of Phulwara oil, Pequi oil, high palmitic sunflower oil, Shea, Kokum, Illipe, Sal and/or Mango oil, or a blend thereof, and/or fractions thereof.

As used herein, “%” or “percentage” relates to weight percentage i.e. wt. % or wt.-% if nothing else is indicated.

The sum of a given component in the vegetable fat composition can never be more than 100% by weight, e.g. the sum of all the fatty acid in the vegetable fat composition can never be more than 100% by weight.

As used herein, “oil” and “fat” are used interchangeably, unless otherwise specified.

As used herein, “vegetable oil” and “vegetable fat” are used interchangeably, unless otherwise specified.

As used herein the term “single cell oil” shall mean oil from oleaginous microorganisms which are species of yeasts, molds (fungal), bacteria and microalgae. These single cell oils are produced intracellular and in most cases during the stationary growth phase under specific growth conditions (e.g. under nitrogen limitation with simultaneous excess of a carbon source). Examples of oleaginous microorganisms are, but not limited to, Mortierella alpineea, Yarrowia lipolytica, Schizochytrium, Nannochloropsis, Chlorella, Crypthecodinium cohnii, Shewanella.

As used herein “edible” is something that is suitable for use as food or as part of a food product, such as a dairy or confectionary product.

For products and methods in the confectionery areas, reference is made to “Chocolate, Cocoa and Confectionery”, B. W. Minifie, Aspen Publishers Inc., 3. Edition 1999.

A food product is a product for human consumption.

By a chocolate or chocolate-like product is meant a product, which at least is experienced by the consumer as chocolate or as a confectionery product having sensorial attributes common with chocolate, such as e.g. melting profile, taste etc. Some chocolate comprises cocoa butter, typically in substantial amounts, where some chocolate-like product may be produced with a low amount of or even without cocoa butter, e.g. by replacing the cocoa butter with a cocoa butter equivalent, cocoa butter substitute, etc. In addition, many chocolate or chocolate-like products comprise cocoa powder or cocoa mass, although some chocolate or chocolate-like products, such as typical white chocolates, may be produced without cocoa powder, but e.g. drawing its chocolate taste from cocoa butter. Depending on the country and/or region there may be various restrictions on which products may be marketed as chocolate.

By compound is meant a product made from a combination of cocoa butter and (vegetable) fats. A compound may also comprise milk fat in various amounts. It is used as a lower-cost alternative to true chocolate, as it uses less-expensive hard (vegetable) fats in place of the more expensive cocoa butter. It may also be known as “compound coating” or “chocolatey coating” when used as a coating for confectionary or candy.

The term “comprising” or “to comprise” is to be interpreted as specifying the presence of the stated parts, steps, features, or components, but does not exclude the presence of one of more additional parts, steps, features, or components.

As used herein, the term “and/or” is intended to mean the combined (“and”) and the exclusive (“or”) use, i.e. “A and/or B” is intended to mean “A alone, or B alone, or A and B together”.

### DETAILED DESCRIPTION OF THE INVENTION

When describing the below embodiments, the present invention envisages all possible combinations and permutations of the below described embodiments with the above disclosed aspects.

The invention relates to a fat composition comprising a vegetable fat phase, wherein the vegetable fat phase comprises:
from 85.0% to 100.0% by weight of triglycerides compared to the total weight of the fat phase;
from 50.0% to 99.5% by weight of SatOSat+SatSatO triglycerides compared to the total weight of triglycerides;
from 51.0% to 92.0% by weight of POP+PPO triglycerides compared to the total weight of triglycerides;
from 0.0% to 15.0% by weight of StOSt+StStO triglycerides compared to the total weight of triglycerides;
a ratio of the weight of PPO triglycerides to the weight of POP triglycerides from 0.00 to 0.05;
   wherein the vegetable fat phase is free from palm oil and/or fractions thereof, and wherein Sat is saturated fatty acids selected from C16-, C18-, C20-, C22-, and/or C24-fatty acids, P is palmitic acid (C16:0), St is steric acid (C18:0), and O is oleic acid (C18:1).

The invention further relates to a fat composition comprising a vegetable fat phase, wherein the vegetable fat phase comprises:
from 85.0% to 100.0% by weight of triglycerides compared to the total weight of the vegetable fat phase;
from 50.0% to 99.5% by weight of SatOSat+SatSatO triglycerides compared to the total weight of triglycerides in the vegetable fat phase;
from 51.0% to 92.0% by weight of POP+PPO triglycerides compared to the total weight of triglycerides in the vegetable fat phase;
from 0.0% to 15.0% by weight of StOSt+StStO triglycerides compared to the total weight of triglycerides in the vegetable fat phase;
a ratio of the weight of PPO triglycerides to the weight of POP triglycerides from 0.00 to 0.05 in the vegetable fat phase;

wherein the vegetable fat phase is free from palm oil and/or fractions thereof, and wherein Sat is saturated fatty acids selected from C16-, C18-, C20-, C22-, and/or C24-fatty acids, P is palmitic acid (C16:0), St is steric acid (C18:0), and O is oleic acid (C18:1).

The fat composition as disclosed herein shows the possibility to produce confectionary or chocolate-like filling or spread compounds without the use of a palm-based vegetable fat phase without compromising the quality.

The fat composition as disclosed herein can be used to produce confectionary or chocolate-like filling or spread compounds which are as bloom stable as traditional confectionary or chocolate-like filling or spread compounds comprising palm mid fraction IV 33.

In one or more embodiments, the vegetable fat phase comprises from 90.0% to 100.0% by weight of triglycerides compared to the total weight of the vegetable fat phase, such as from 93.0% to 100.0% by weight, such as from 94.0% to 99.0% by weight, or such as from 95.0% to 97.0% by weight of triglycerides compared to the total weight of the vegetable fat phase.

In one or more embodiments, the vegetable fat phase comprises from 52.0% to 95.0% by weight of SatOSat+SatSatO triglycerides compared to the total weight of triglycerides, such as from 54.0% to 90.0% by weight, such as from 60.0% to 89.0% by weight, such as from 64.0% to 89.0% by weight, or such as 66.0% to 88.0% by weight of SatOSat+SatSatO triglycerides compared to the total weight of triglycerides in the vegetable fat phase; wherein Sat is saturated fatty acids selected from C16-, C18-, C20-, C22-, and/or C24-fatty acids, and wherein O is oleic acid (C18:1).

In one or more embodiments, the vegetable fat phase comprises from 52.0% to 90.0% by weight of POP+PPO triglycerides compared to the total weight of triglycerides, such as from 54.0% to 85.0% by weight, such as from 56.0% to 84.0% by weight, such as from 58.0% to 83% by weight, or such as from 62.0% to 81.0% by weight of POP+PPO triglycerides compared to the total weight of triglycerides in the vegetable fat phase; wherein P is palmitic acid (C16:0) and O is oleic acid (C18:1).

In one or more embodiments, vegetable fat phase comprises from 0.0% to 12.0% by weight of StOSt+StStO triglycerides compared to the total weight of triglycerides, such as from 0.1% to 10.0% by weight, such as from 0.2% to 5.0% by weight, or such as 0.3% to 3.0% by weight of StOSt+StStO triglycerides compared to the total weight of triglycerides in the vegetable fat phase; wherein St is steric acid (C18:0) and O is oleic acid (C18:1).

In one or more embodiments, the ratio of the weight of PPO triglycerides to the weight of POP triglycerides is from 0.00 to 0.04, such as 0.00 and 0.03; wherein P is palmitic acid (C16:0) and O is oleic acid (C18:1).

In one or more embodiments, the vegetable fat composition comprises vegetable fat components originating from Phulwara oil, Pequi oil, high palmitic sunflower oil, Cotton seed oil, Pistachio oil, Buckwheat oil, Andiroba oil, Mahua seed oil, Palash oil, Pilu oil, and/or Sea Buckthorn oil, and fractions thereof.

In one or more embodiments, the vegetable fat phase is originating from Phulwara oil (Diploknema butyracea), such as a Phulwara mid fraction. The examples clearly demonstrate that Phulwara mid-fractions can be used as an alternative to palm fractions in order to make non-palm fillings or spreads.

Use of the fat composition according to the present invention for bakery, dairy, or confectionary filling applications, such as bakery fillings and confectionary fillings; or for chocolate or chocolate-like spreads.

A confectionary or chocolate or chocolate-like filling or spread product comprising from 15% to 65% by weight, such as from 20% to 60%, such as from 25% to 55%, such as from 28% to 50%, or such as from 30% to 45% by weight of a fat composition according to the present invention.

The present invention is further illustrated by the following examples, which are not to be construed as limiting the scope of protection.

### EXAMPLES

### Example 1: CBE Compositions

Table 1 displays a typical selected triglyceride composition for a palm mid-fraction IV 33, Phulwara (Diploknema butyracea), a Phulwara mid fraction measured by AOCS method Ce 5b-89. The asymmetric isomers are included in the amount specified under each TAGs in the examples, since the method used (AOCS Ce 5b-89) does not measure the difference in isomeric state of a TAG. Hence, for example, when there is written POSt in the tables, it also includes its isomers; PStO and StPO.

The content of PPO was determined using a well-known method by a commercial laboratory. The amount of the asymmetric PPO isomer is measured using an absolute method. Thereafter, the ratio of PPO/POP triglycerides was calculated.

The Phulwara mid fraction was obtained via acetone solvent fractionation with a ratio of oil to solvent at 1 to 6. First fractionation at 20° C. resulted in 12% Stearin and 88% olein. Secondly the olein was fractionated once more at 0° C. to obtain 71% Stearin (mid fraction) and 29% olein (double olein/super olein).

TABLE 1

| | | |
|---|---|---|
| | | Phulwara |
| Palm mid | Phulwara | (Diploknema |
| fraction | (Diploknema | butyracea) |
| IV 33 | butyracea) | mid fraction |

Triglyceride composition*

| | | | |
|---|---|---|---|
| MOP/wt. % | 2.2 | 0.8 | 0.8 |
| POP/wt. % | 66.7 | 63.1 | 80.0 |
| POSt/wt. % | 13.5 | 5.2 | 6.5 |
| StOSt/wt. % | 1.6 | 0.3 | 0.4 |
| StOA/wt. % | 0.2 | — | — |
| AOA/wt. % | 0.1 | — | — |
| Total SatOSat/wt. % | 84.3 | 69.4 | 87.7 |
| Total SatSatSat/wt. % | 3.5 | 5.8 | 2.4 |

Triglyceride position ratio

| | | | |
|---|---|---|---|
| PPO/POP | 0.07 | 0.00 | 0.00 |

*Measured using AOCS Ce5b-89 - Relative measurements summing the TAG composition to 100%.

Phulwara has a high content of SatOSat of 69.4 wt. %, but also a significant content of SatSatSat of 5.8 wt. %. It is well known that SatSatSat levels above a certain threshold (approximately 2-3 wt. %) can give viscosity build up issues during tempering, and hence Phulwara oil may not be best suited for a tempered filling or spread fat.

The Phulwara mid-fraction has a very high SatOSat content of 87.7 wt. %, which is somewhat higher than the SatOSat content of 84.3 wt. % of a palm mid-fraction IV 33. Furthermore, the SatSatSat content is 2.4 wt. %, which is lower than the SatSatSat of 3.5 wt. % for palm-mid fraction IV 33. Interesting to note is the low contents of POSt and StOSt and hence the high POP of 80.0 wt. % in the Phulwara mid-fraction. The Phulwara mid fraction seems very well suited as a temper filling or spread fat.

Furthermore, the PPO/POP ratio for Phulwara mid-fraction is substantially lower than Palm mid fraction IV 33.

### Example 2: Recipes and Manufacture of Chocolate-Like Filling Compositions

The procedure of the chocolate productions was all done following this procedure: All ingredients, except lecithin and some of the fat, are mixed on a teddy mixer with heat jacket to a consistency of marzipan. Afterwards, the mixture is refined a on three roller Bühler refiner to an average particle size of 20 micron. The refined mass is conched together with the remaining fat for 6 hours at 50° C. on a teddy mixer. Half an hour before conching is complete lecithin is added. Fillings are then transferred to an Aasted AMC 50 three zone tempering machine to be optimally tempered. Tempering settings are adjusted until a well temper curve with the highest possible inflection point is obtained on an exotherm 7400 Temper Meter. The inflection point correlates to the crystallization point of the product. Filling recipes and fat composition and well as inflection point and slope for temper curves are given in Table 2.

TABLE 2

| Chocolate fillings. Reference's and | | | |
|---|---|---|---|
| Phulwara based fillings. | | | |
| Hazel Filling | Hazel | Cocoa Filling | Cocoa |
| comparative | Filling | comparative | Filling |

Recipe

| | | | | |
|---|---|---|---|---|
| Sugar/wt. % | 42.58 | 42.58 | 35.58 | 35.58 |
| Cocoa powder | 8.0 | 8.0 | 5.0 | 5.0 |
| (11% CB)/wt. % | | | | |
| Cocoa mass/wt. % | — | — | 2.0 | 2.0 |
| Skim milk | 3.0 | 3.0 | 10.0 | 10.0 |
| powder/wt. % | | | | |
| Whole milk | 8.0 | 8.0 | 12.0 | 12.0 |
| powder/wt. % | | | | |
| Hazel nut | 12.0 | 12.0 | — | — |
| paste/wt. % | | | | |
| Lecithin/wt. % | 0.4 | 0.4 | 0.4 | 0.4 |
| Vanillin/wt. % | 0.02 | 0.02 | 0.02 | 0.02 |
| PMF IV 33/wt. % | 26.0 | — | 35.0 | — |
| Phulwara mid | — | 26.0 | — | 35.0 |
| fraction/wt. % | | | | |
| Total fat | 36.9 | 36.9 | 39.8 | 39.8 |
| content/wt. % | | | | |

Fat composition

| | | | | |
|---|---|---|---|---|
| Cocoa butter/wt. % | 2.4 | 2.4 | 4.3 | 4.3 |
| PMF IV 33/wt. % | 70.4 | — | 87.9 | — |
| Phulwara mid | — | 70.4 | — | 87.9 |
| fraction/wt. % | | | | |
| Hazel nut oil/wt. % | 21.5 | 21.5 | — | — |
| Milk fat/wt. % | 5.7 | 5.7 | 7.8 | 7.8 |

Temper curves

| | | | | |
|---|---|---|---|---|
| Inflection | 17.2 | 17.6 | 19.1 | 18.8 |
| point/° C. | | | | |
| Slope | 0.1 | 0.0 | 0.2 | −0.1 |

The tempering of the Phulwara based Hazel and cocoa fillings on the Aasted AMC 50 three zone tempering machine was straight forward with comparable temperature settings as the hazel and cocoa comparable fillings, respectively. Furthermore, no viscosity build-up over time in the recirculated tempered fillings were observed. This combined with comparable inflection points for the Phulwara mid-fraction and palm mid-fraction IV 33 based fillings, strongly indicate that Phulwara based fillings will be workable in chocolate applications with respect to the production process.

The absence of asymmetric PPO in the CBE of the invention as compared the comparative filling consisting Palm mid fraction IV 33 is an added advantage of the present invention, as the presence of PPO or asymmetric TAG's in general generally result in lower temperature settings in the crystallization and outlet zone of the temper unit, which can have a negative impact to crystallization in the pursuing cooling tunnel. Furthermore, a minor impact to texture towards a softer product can also be a consequence of the presence of asymmetric monounsaturated (SatSatO) TAGs in the fat composition

### Example 3: Bloom Stability

The fillings are deposited into plastic cups (50 g fillings into each) and placed in a three-zone cooling tunnel for 30 minutes. Temperatures are adjusted to 15° C. in zone 1 and 3 and 12° C. in zone 2. The cups are kept at 20° C. for one week and then moved to 15° C. and 20° C. cabinet for isothermal storage. Once a week the fillings are evaluated by a trained panel of experts for visible recrystallization on the surface of the fillings. The number of weeks till the appearance of many large clearly visible crystals in the surface of the filling are noted as the shelf life result. The shelf life results are given in table 3.

TABLE 3

| Chocolate fillings. Reference's and | | | |
|---|---|---|---|
| Phulwara based fillings. | | | |
| | | | Cocoa |
| Hazel Filling | Hazel | Cocoa Filling | Filling |
| comparative | Filling | comparative | II |

Bloom Stability

| | | | | |
|---|---|---|---|---|
| Weeks before presence | >12 | >12 | >12 | >12 |
| of large clearly visible | | | | |
| crystals on the filling | | | | |
| surface at 15° C. | | | | |
| isothermal storage | | | | |
| Weeks before presence | >12 | >12 | >12 | >12 |
| of large clearly visible | | | | |
| crystals on the filling | | | | |
| surface at 20° C. | | | | |
| isothermal storage | | | | |

None of the fillings display any visible crystals on the surface of the fillings due to recrystallization even after more than 12 weeks of storage at 15 and 20° C. This clearly demonstrates that the hazel and cocoa fillings based on Phulwara mid-fraction are stable over time and will be an interesting non-palm tempered filling alternative.

1. A fat composition comprising a vegetable fat phase, wherein the vegetable fat phase comprises:
from 85.0% to 100.0% by weight of triglycerides compared to the total weight of the vegetable fat phase;
from 50.0% to 99.5% by weight of SatOSat+SatSatO triglycerides compared to the total weight of triglycerides in the vegetable fat phase;
from 51.0% to 92.0% by weight of POP+PPO triglycerides compared to the total weight of triglycerides in the vegetable fat phase;
from 0.0% to 15.0% by weight of StOSt+StStO triglycerides compared to the total weight of triglycerides in the vegetable fat phase;
a ratio of the weight of PPO triglycerides to the weight of POP triglycerides from 0.00 to 0.05 in the vegetable fat phase;
wherein the vegetable fat phase is free from palm oil and/or fractions thereof, and wherein Sat is saturated fatty acids selected from C16-, C18-, C20-, C22-, and/or C24-fatty acids, P is palmitic acid (C16:0), St is steric acid (C18:0), and O is oleic acid (C18:1).

2. The fat composition of claim 1, wherein the vegetable fat phase comprises from 90.0% to 100.0% by weight of triglycerides compared to the total weight of the vegetable fat phase, such as from 93.0% to 100.0% by weight, such as from 94.0% to 99.0% by weight, or such as from 95.0% to 97.0% by weight of triglycerides compared to the total weight of the vegetable fat phase.

3. The fat composition of claim 1, wherein the vegetable fat phase comprises from 52.0% to 95.0% by weight of SatOSat+SatSatO triglycerides compared to the total weight of triglycerides in the vegetable fat phase; wherein Sat is saturated fatty acids selected from C16-, C18-, C20-, C22-, and/or C24-fatty acids, and wherein O is oleic acid (C18:1).

4. The fat composition of claim 1, wherein the vegetable fat phase comprises from 52.0% to 90.0% by weight of POP+PPO triglycerides compared to the total weight of triglycerides in the vegetable fat phase; wherein P is palmitic acid (C16:0) and O is oleic acid (C18:1).

5. The fat composition of claim 1, wherein the vegetable fat phase comprises from 0.0% to 12.0% by weight of StOSt+StStO triglycerides compared to the total weight of triglycerides in the vegetable fat phase; wherein St is steric acid (C18:0) and O is oleic acid (C18:1).

6. The fat composition of claim 1, wherein the ratio of the weight of PPO triglycerides to the weight of POP triglycerides is from 0.00 to 0.04; wherein P is palmitic acid (C16:0) and O is oleic acid (C18:1).

7. The fat composition of claim 1, wherein the vegetable fat composition comprises vegetable fat components originating from Phulwara oil, Pequi oil, high palmitic sunflower oil, Cotton seed oil, Pistachio oil, Buckwheat oil, Andiroba oil, Mahua seed oil, Palash oil, Pilu oil, and/or Sea Buckthorn oil, and fractions thereof.

8. The fat composition according to claim 7, wherein the vegetable fat composition comprises vegetable fat components originating from Phulwara (Diploknema butyracea) and/or Pequi oil (Caryocar brasiliense), and fractions thereof.

9. The fat composition according to claim 1, wherein the fat composition is a filling or spread fat.

10. A method of making a fat composition comprising addition of the vegetable fat phase according to claim 1, the fat composition employed for bakery, dairy, or confectionary filing applications; or for chocolate or chocolate-like spreads.

11. A confectionary or chocolate or chocolate-like filing product comprising from 15% to 65% by weight of a fat composition according to claim 1.
